(19) United States
(12) Patent Application Publication
(10) Pub. No.: US 2010/0093370 A1
(43) Pub. Date: Apr. 15, 2010

(54) METHOD FOR CONFIRMING A READING POSITION USING A SHORT MESSAGE SERVICE MESSAGE AND SYSTEM FOR PERFORMING THE SAME

(76) Inventors: Sung-Yong Choi, Seoul (KR); Kwang-Hyun Lee, Gyeonggi-do (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/597,606

(22) PCT Filed: Apr. 16, 2008
(86) PCT No.: PCT/KR08/02145

§ 371 Date: Oct. 26, 2009

(30) Foreign Application Priority Data
Apr. 27, 2007 (KR) 10-2007-0041086

(51) Int. Cl. H04W 4/12; H04W 4/02

(52) U.S. Cl. 455/456.1; 455/466

(57) ABSTRACT

A method for confirming an SMS message reading position and a system for performing the method are disclosed. A reading-position confirmation terminal device includes a display part, a wireless circuit part and a control part. The wireless circuit part sets a communication channel with a mobile communication network system. The control part transmits an SMS message and information requesting a reading time and a reading position in accordance with a reading the SMS message through the wireless circuit part, and displays the reading time and the reading position to the display part when a time and a position in accordance with a reading of the SMS message by a user of a receiving mobile phone. Therefore, a transmitting mobile phone may confirm a reading position of the corresponding SMS message, so that the position of the SMS message receiving side may be easily checked by the transmitting mobile phone.

### TECHNICAL FIELD

The present invention relates to a method for confirming a short message service (SMS) message reading position and a system for performing the method, and more particularly, to a method for confirming an SMS message reading position by using an SMS message and a system for performing the method.

### BACKGROUND ART

Generally, a short message service (SMS) message in a code division multiple access (CDMA) system is easily realized by its inherent data transmission function in the CDMA communication system.

The SMS message has a two-way paging function, and thus enables various services such as a text message receiving service, voicemail notification, a text message transmitting service, etc. In the SMS, a mobile communication system and a mobile communication terminal communicate with each other by using a data burst message defined in the IS-95-A standard. The data burst message, however, is considerably restricted in its length. Specifically, the length of a receiving data burst message is limited to about 150 bytes, and the length of a transmitting data burst message is limited to about 100 bytes.

The SMS may be classified as a mobile terminated (MT) SMS for receiving messages, a mobile originated (MO) SMS transmitting messages, a broadcast-type information service similar to wireless paging, an information-on-demand service using a bidirectional communication characteristics. Alternatively, the SMS may be used for various remote control services.

Recently, as the supply rate of mobile phones has been increased, the SMS message service has become widely used. When a transmitting mobile phone transmits an SMS message to a receiving mobile phone via a mobile communication network system, the SMS message service is realized. The above process is only used to inform that the SMS message of the transmitting side is normally received by a short message service center (SMSC) server of a mobile communication network system which manages an SMS service, and a transmitting process of an SMS message is ended when the corresponding SMS message is transmitted.

Thus, the transmitting side cannot check whether or not the receiving side has read the SMS message, so that accuracy for a communication delivery between the transmitting side and the receiving side may be lowered. Thus, this may cause a problem when the transmitting side transmits an important SMS message.

Meanwhile, as mobile communication services have become widespread, most people are receiving at least one type of mobile communication service. The mobile communication services include voice communication, text messaging, voicemail, and have expanded to include wireless Internet services, position-tracking functions, etc.

A position-tracking function using a mobile communication terminal may be realized by a method using a cell position registered in a home position register (HLR) or a method using position information from the Global Positioning System (GPS).

The method using cell position information has an error according to a certain cell radius, that is, many kilometers, so that it is difficult to track the exact position. However, when the GPS system or a differential GPS (DGPS) system is used in the cell position method, it is possible to provide a relatively exact position with an error of several meters to tens of meters. This type of position service may be applied in an emergency, such as a traffic accident, traffic information, commercial use such as logistics, etc.

### DISCLOSURE OF THE INVENTION

### Technical Problem

The present invention provides a method for confirming a short message service (SMS) message reading position by using an SMS message so as to confirm an SMS message reading position at a receiving side through an SMS message.

The present invention also provides a system for performing the above-mentioned method.

### Technical Solution

According to one aspect of the present invention, in a method for confirming an SMS reading position by using an SMS message, which confirms whether or not an SMS message provided from a transmitting mobile phone has been read at a receiving mobile phone, the method comprises: (a) transmitting an SMS message executed by a user subscribed to an SMS message reading confirming service and information requesting a reading time and a reading position in accordance with a reading of the SMS message; and (b) displaying a reading time and reading-position information of the SMS message when the reading time and the reading-position information of the SMS message are provided by a receiver from the receiving mobile phone.

In an example embodiment of the present invention, step (a) may include: (a-1) checking whether or not position information according to an SMS message reading as the SMS message has been composed; (a-2) transmitting an SMS message including a position information request, when a position information request according to a reading is checked in step (a-1); and (a-3) transmitting an SMS message which a position information request is not included, when a position information request according to a reading is not checked in step (a-1).

In an example embodiment of the present invention, step (b) may include: (b-11) parsing the reading confirming information in accordance with a receipt of the reading confirming information; (b-12) displaying a reading time that is extracted in accordance with the parsing; (b-13) checking whether the reading-position information that is extracted in accordance with the parsing exists or not; and (b-14) ending when the reading-position information is not in step (b-3) and displaying the corresponding reading-position information when the reading-position information is in step (b-3).

In an example embodiment of the present invention, step (b) may include: (b-21) displaying a reading time when the reading confirming information is received; (b-22) checking whether a position search request of a receiving has been made or not; (b-23) requesting a position search of the receiving side when the position search request of the receiving is checked in step (b-22); and (b-24) when the reading-position information has been received, displaying corresponding reading-position information.

In an example embodiment of the present invention, the position information may include at least one of address information and map information of the receiving mobile phone.

In an example embodiment of the present invention, information requesting the reading time and information requesting the reading position may be transmitted at substantially the same time, and the reading-position information may be transmitted with the reading time.

In an example embodiment of the present invention, the reading-position information may be obtained in accordance with a request of a user after the reading time is transmitted. For one example, the reading-position information may be forcibly obtained when the receiving mobile phone is subscribed to an SMS message reading confirming service. For another example, the reading-position information may be obtained in accordance with position information confirmation permission of the receiving mobile phone according to the corresponding SMS message reading.

According to another aspect of the present invention, in method for confirming a reading position of an SMS using an SMS message, which confirms whether or not an SMS message provided from a transmitting mobile phone has been read at a receiving mobile phone, the method includes (a) when the SMS message is provided from the transmitting mobile phone, checking whether or not information requesting a position confirmation of a reader is included in the SMS message; (b) when the information requesting a position confirmation of the reader is not included in the SMS message, and a reading confirmation message of the SMS message by a receiver is provided from the receiving mobile phone, transmitting the corresponding reading confirmation message to the transmitting mobile phone; and (c) when the information requesting a position confirmation of the reader is included in the SMS message, and a reading confirmation message of the SMS message by a receiver is provided from the receiving mobile phone, transmitting the reading confirmation message including a reading position of the receiving mobile phone to the transmitting mobile phone.

In an example embodiment of the present invention, the reading position of the receiving mobile phone may include at least one of address information of the receiving mobile phone and map information of the receiving mobile phone.

According to still another aspect of the present invention, a reading-position confirmation terminal device for confirming a reading position of an SMS message by using an SMS message includes a display part, a wireless circuit part and a control part. The wireless circuit part sets a communication channel with a mobile communication network system. The control part transmits an SMS message composed by a user and information requesting a reading time and a reading position in accordance with a reading the SMS message through the wireless circuit part, and displays the reading time and the reading position to the display part when a time and a position in accordance with a reading of the SMS message by a user of a receiving mobile phone.

### ADVANTAGEOUS EFFECTS

According to the method for confirming an SMS message reading position and the system for performing the method, as a receiving side reads an SMS message, a transmitting mobile phone may confirm a reading position of the corresponding SMS message, so that the position of the SMS message receiving side may be easily checked by the transmitting mobile phone. Moreover, a reading time may also be obtained in addition to the reading position information, so that usability of an SMS message may be provided to the SMS message transmitting side.

### BRIEF DESCRIPTION OF THE DRAWINGS

The above and other advantages of the present invention will become more apparent by describing in detail example embodiments thereof with reference to the accompanying drawings, in which:

FIG. 1 is a schematic diagram illustrating a service system performing a function of a reading-position confirmation service of a short message service (SMS) message using an SMS message according to an embodiment of the present invention;

FIGS. 2 to 4 are images showing an example of a mobile phone screen according to a reading-position confirmation service of an SMS message using an SMS message according to the present invention;

FIG. 5 is a block diagram illustrating a mobile phone having a function of a reading-position confirmation service of an SMS message using an SMS message according to the present invention;

FIG. 6 is a data packet diagram illustrating a message structure of each layers of IS-637;

FIG. 7 is a flowchart schematically illustrating a method of a reading-position confirmation service of an SMS message using an SMS message according to an embodiment of the present invention;

FIG. 8 is a flowchart schematically illustrating an example of a step displaying reading-position information of FIG. 7;

FIG. 9 is a flowchart schematically illustrating another example of a step displaying reading-position information of FIG. 7;

FIG. 10 is a flowchart schematically illustrating a method of a reading-position confirmation service of an SMS message using an SMS message according to another embodiment of the present invention;

FIG. 11 is a flowchart schematically illustrating a method of a reading-position confirmation service of an SMS message using an SMS message according to still another embodiment of the present invention;

FIG. 12 is flowchart schematically illustrating a method of a reading-position confirmation service of an SMS message using an SMS message according to more still another embodiment of the present invention; and

FIG. 13 is flowchart schematically illustrating a method of a reading-position confirmation service of an SMS message using an SMS message according to further still another embodiment of the present invention.

### BEST MODE FOR CARRYING OUT THE INVENTION

It should be understood that the example embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

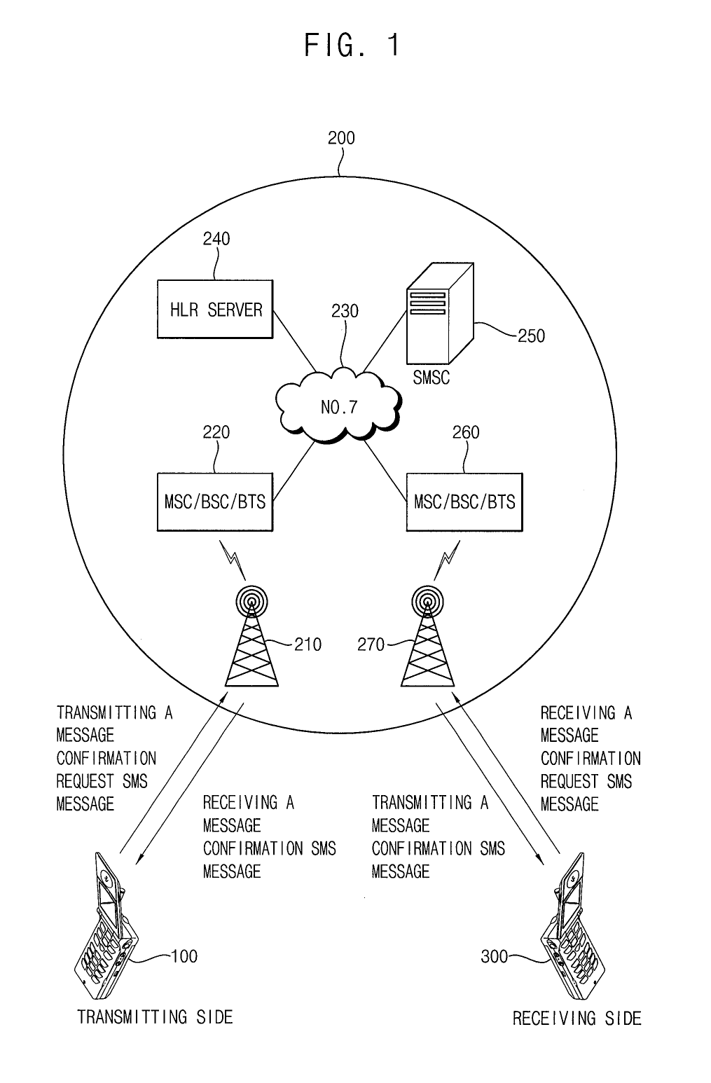

FIG. 1 is a schematic diagram illustrating a service system performing a function of a reading-position confirmation service of a short message service (SMS) message using an SMS message according to an embodiment of the present invention. FIGS. 2 to 4 are images showing an example of a mobile phone screen according to a reading-position confirmation service of an SMS message using an SMS message according to the present invention.

Referring to FIGS. 1 to 4, in order to realize a service system of a reading-position confirmation of an SMS message by using an SMS message, the service system according to an embodiment of the present invention includes a transmitting mobile phone 100, a mobile communication network system 200 and a receiving mobile phone 300. In this embodiment, for ease of description, a side firstly transmitting an SMS message is defined as a transmitting side, and an action transmitting an SMS message by the transmitting side is defined as a transmission. Moreover, a side receiving the SMS message is defined as a receiving side, and an action receiving an SMS message by the receiving side is defined as a receipt.

The transmitting mobile phone 100 provides the receiving mobile phone 300 with a message confirmation request SMS message via the mobile communication network system 200. The transmitting mobile phone 100 receives a message confirmation SMS message that is delivered when the receiving mobile phone 300 receives a message confirmation request SMS message, and checks the SMS message stored in an outbox as a reading confirmation. The reading confirmation may be processed such as a check box image, an underline, an open-envelope image, etc. For example, the message confirmation request SMS message is included in the composed SMS message to be transmitted.

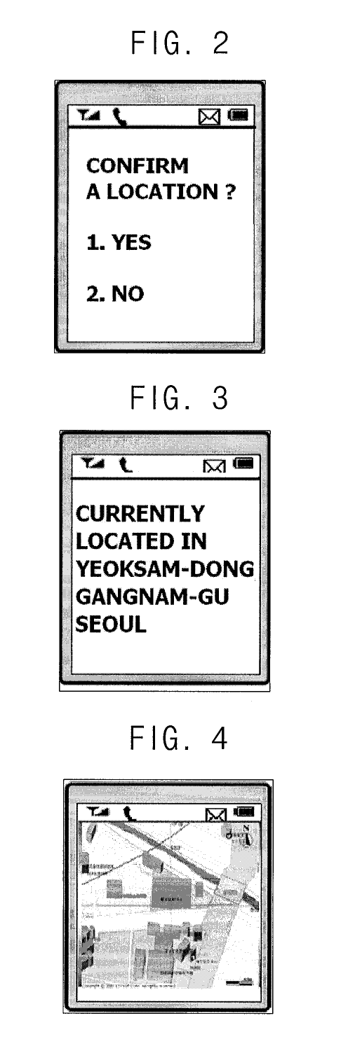

The transmitting mobile phone 100 may display a screen which confirms position information of the receiving mobile phone 300 according to a user's selection, as shown in FIG. 2. When position information confirmation of the receiving mobile phone 300 is selected by a user, the transmitting mobile phone 100 may receive reading-position information of the receiving mobile phone 300. For example, the position information provided to the transmitting mobile phone 100 may include position information of a text type as shown in FIG. 3. Alternatively, the position information provided to the transmitting mobile phone 100 may include position information of an image type such as map information, sketch information, etc., as shown in FIG. 4.

The mobile communication network system 200 includes a transmitting base station 210, a transmitting exchange 220, a No. 7 mobile communication network 230, a home position register (HLR) server 240, a short message service center (SMSC) server 250, a receiving exchange 260 and a receiving base station 270, and sets a communication channel between the transmitting mobile phone 100 and the receiving mobile phone 300. The transmitting exchange 220 includes a mobile switching center (MSC), a base station controller (BSC) and a base transceiver station (BTC).

The HLR server 240 manages subscriber data of a reading-position confirmation of an SMS message by using an SMS message and information such as a position, a possibility of receiving, an additional service, etc., for a receiving mobile phone. For example, the HLR server 240 may search for the position of the receiving mobile phone when information requesting a position confirmation of a reader is included in the SMS message, and may provide the SMSC server 250 with the searched position of the reader.

The SMSC server 250 transmits an SMS message to the receiving mobile phone, and controls that a message confirmation SMS message in accordance with the SMS message confirmation is provided to the transmitting mobile phone. In this embodiment, when information requesting a position confirmation of a reader is included in the SMS message, the SMSC server 250 provides the transmitting mobile phone 100 with the SMS message including the searched position.

The receiving mobile phone 300 stores the message confirmation request SMS message through the mobile communication network system 200, and provides the message confirmation SMS message to the transmitting mobile phone 100 when the stored message confirmation request SMS message is confirmed by a user.

The transmitting mobile phone 100 and the receiving mobile phone 300 according to the present invention may commonly load software that is programmed to perform the following functions. That is, software is commonly loaded in the receiving and transmitting mobile phones 100 and 300, which is programmed to be performed a method of reading-position confirmation of an SMS message by using an SMS message which confirms whether or not the SMS message transmitted by the transmitting mobile phone has been read in a receiving mobile phone. Here, the SMS message includes a teleservice identification (TID) for using an SMS push message to be used for identifying an ID for a reading confirmation.

For example, the transmitting mobile phone loads the software program which loads a process storing the transmitted SMS message to an outbox thereof, a process comparing the SMS message stored in the outbox and the SMS message stored in the inbox when the transmitting mobile phone is the reading confirmation service member and the reading confirmation message has been received, and a process displaying the corresponding SMS message as the reading confirmation when a matching SMS message is in the outbox. Additionally, when the matching SMS message is in the inbox at the comparing process, the software program may further load a process removing the corresponding SMS message.

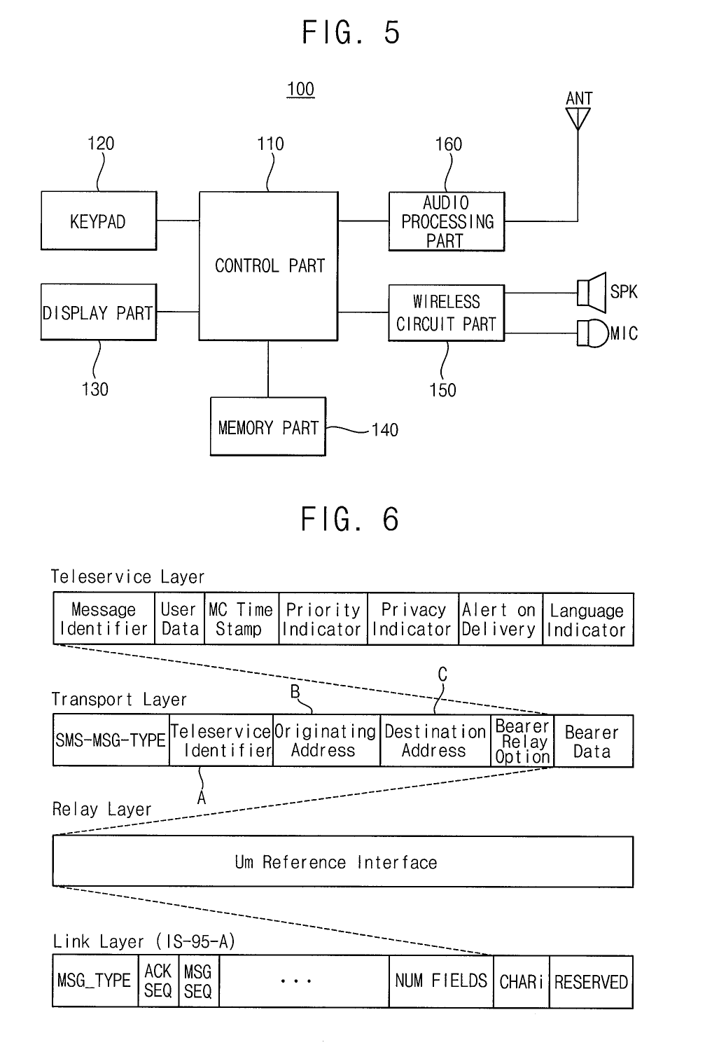

FIG. 5 is a block diagram illustrating a mobile phone having a function of a reading-position confirmation service of an SMS message using an SMS message according to the present invention.

Referring to FIG. 5, a mobile phone 100 having a service function of a reading-position confirmation of an SMS message by using an SMS message includes a control part 110, a keypad 120, a display part 130, a memory part 140, an audio processing part 150 and a wireless circuit part 160.

The control part 110 controls whole function of a mobile phone through receiving or transmitting signals with elements such as the keypad 120, the display part 130, the memory part 140, the audio processing part 150 and the wireless circuit part 160.

As the message confirmation request SMS message is composed by a user in an SMS message transmitting mode, the control part 110 stores the composed message confirmation request SMS message in the outbox, and controls to be provided the mobile communication network system by using a communication channel that is set by the wireless circuit part 160. For example, the outbox may be stored in the memory part 140.

For example, as the message confirmation request SMS message is received, the control part 110 compares the message confirmation SMS message delivered through the mobile communication network system and the various message confirmation request SMS messages stored in the mobile phone, and controls that the stored corresponding message confirmation request SMS message is checked as a reading confirmation. Here, the comparing process between the message confirmation SMS message and the message confirmation request SMS messages may be performed by using a virtual machine (VM). The VM is a so-called application program which is driven by an operating system (OS) for a mobile phone. In the comparing process, the compared list may include a transmitting mobile phone number, a receiving mobile phone number, a transmitting-receiving time, etc., that are displayed on the SMS message.

The message confirmation request SMS message may be stored in an outbox of a mobile phone. Alternatively, the message confirmation request SMS message may be stored in an inbox of the mobile phone.

In the SMS message receiving mode, the control part 110 controls that the message confirmation request SMS message provided from a transmitting side by using a communication channel that is set with the communication network system is stored to an inbox, and the receiver side is alerted to the stored message confirmation request SMS message. For example, the inbox may be stored in the memory part 140.

As the stored message confirmation request SMS message is confirmed by a user, the control part 110 controls the message confirmation SMS message to be transmitted to the transmitting side via the mobile communication network system.

The transmitting mobile phone 100 may confirm a reading time and a reading position of the SMS message. For one example, the control part 110 may transmit an SMS message composed by a user and information requesting a reading time and a reading position in accordance with a reading of the SMS message. Here, the control part 110 may control that the reading time and the reading position are displayed on the display part when the reading time and the reading position are provided.

For another example, the control part 110 may transmit an SMS message requesting a position confirmation to a receiving mobile phone. Here, the control part 110 may control that the position of the receiving mobile phone is displayed on the display part when the SMS message including the position is received from the receiving mobile phone.

The keypad 130 includes a functional button for performing a function and a general button for inputting letters and numbers as an inputting means transmitting a command of a user, and performs a function of transmitting a command of a user to the control part 110.

The display part 130 may display an information screen displaying information of a mobile phone, a menu screen displaying various functions, an input screen for inputting letters and numbers, a result screen displaying the result of the function, etc., in accordance with a control of the control part 110. Thus, a mobile phone user views the screens and selects a desired function. In this embodiment, as shown in FIG. 2, a screen for user selection may be displayed in order to realize an searching a position information of a receiving mobile phone. Thus, as shown in FIG. 3, the display part 130 may display position information of a text type of the receiving mobile phone. Alternatively, as shown in FIG. 4, the display part 130 may display position information of the receiving mobile phone, which is a map type or a sketch type.

The memory part 140 loads a program which drives a function that is processed by the control part 110, a program which realizes convenient and various functions for a user, etc. The memory part 140 generally includes a flash memory, a random access memory (RAM) and a read-only memory (ROM).

The flash memory loads a real time operating system (OS) and calls processing software of a mobile phone, and read variable factors and status of the programs from the RAM to operate the real time operating system (OS) and the calls processing software. The ROM may include an electrically erasable programmable read-only memory (EEPROM), and stores nonvolatile data which can be erasable and rewritten to perform input/output according to a command of the control part 100. The ROM may store a number assignment module (NAM) parameter, data for storing (i.e., a phone number and a name, a character message, a moving image and so on), etc.

Moreover, the flash memory is a nonvolatile memory having a high processing speed and keeping data. When a mobile phone is upgraded, the flash memory may load upgraded software. For example, the flash memory loads a program that performs a function of adding a message confirmation request to a transmitting message, and a function of transmitting a message confirmation SMS message to a transmitting mobile phone when the receiving user reads the SMS message.

Additionally, the memory part 140 may store a received character message, system information for managing the mobile phone, etc. For example, the memory part 140 includes a first area that is set as an outbox and a second area that is set as an inbox. The first area may store the transmitting SMS messages, and the second area may store the receiving SMS message and a reading confirmation SMS message corresponding to own transmitting SMS message. As a memory capacity is considered, the reading confirmation SMS message may removed in accordance with a user's selection and may be automatically removed when the transmitting SMS message that is stored in the outbox is displayed as a reading confirmation.

The audio processing part 150 converts, for example, analog-type audio recorded through a microphone of a mobile phone into digital-type audio to transmit the digital audio to the control part 110. Alternatively, the audio processing part 150 processes data received from the exterior to output an analog type audio through a speaker (SPK).

The wireless circuit part 160 is set a communication channel with a mobile communication network system to receive at least one of calls, character messages and audio data through an antenna (ANT) and transmits the calls, the character messages and the audio data to the control part 110. Moreover, the wireless circuit part 160 may perform a role of transmitting data that is stored in the memory part 140 to a transmitting telephone through the antenna (ANT).

As described above, a mobile phone according to the present invention loads a program that performs a function of adding a message confirmation request to a transmitting message by a transmitting side, and a function of transmitting a message confirmation SMS message to a transmitting mobile phone when the receiving user reads the SMS message received from the transmitting side, so that an accuracy for a communication delivery between the transmitting side and the receiving side may be achieved.

A layer structure for identification of an SMS message will be described with reference to FIG. 6.

FIG. 6 is a data packet diagram illustrating a message structure of each layers of IS-637.

Referring to FIG. 6, a CHARi message of a data burst message (or a link layer) includes an SMS parameter that is encapsulated, and the CHARi message is analysis to be transmitted to an upper layer.

A transport layer is set through a Um interface of a relay layer based on data burst message of IS-95-A standard performing a role of a link layer. The transport layer includes a teleservice identifier ‘A’ that is a service identifier such as a vocal post office box and a general message, a transmitting side originating address ‘B’, a receiving side destination address ‘C’, a bearer reply option and bearer data. The bearer data may form a teleservice layer.

The teleservice layer includes a message identifier, a user data having a receiving contents, a message center time stamp (MC time stamp) for the corresponding message, a priority indicator, a privacy indicator, a message alert on delivery and a language indicator to provide an application service.

A formation of a message identifier included in the teleservice layer is described in the following Table 1.

TABLE 1

| Field | Length (bits) |
|---|---|
| SUBPARAMETER_ID | 8 |
| SUBPARAM_LEN | 8 |
| MESSAGE_TYPE | 4 |
| MESSAGE_ID | 16 |
| RESERVED | 4 |

Referring to Table 1, the “SUBPARAMETER_ID” field having an eight-bit length is a field for identifying a message identifier. The “SUBPARAM_LEN” field having an eight-bit length is a field that stores a length data following message. The “MESSAGE_TYPE” field having a four-bit length is a field for identifying one of five types whether the corresponding message is a deliver message, the corresponding message is a submit message, etc. The “MESSAGE_ID” field having a sixteen-bit length is a field for identifying a message at a teleservice end point outputting a message.

A predetermined value capable of identifying by a transmitting side is set in the SUBPARAMETER_ID value set as 8 bits (i.e., 00000000), so that the reading position and reading time confirmation service of an SMS message by using an SMS message according to the present invention may be performed.

For example, as a user using a mobile phone is subscribed to the reading position and reading time service, the SUBPARAMETER_ID value is set from <00000000> to <11111111>. Then, the mobile communication network system identifies the SUBPARAMETER_ID value set as <11111111>, so that the reading position and reading time confirmation service of an SMS message by using an SMS message according to the present invention may be processed.

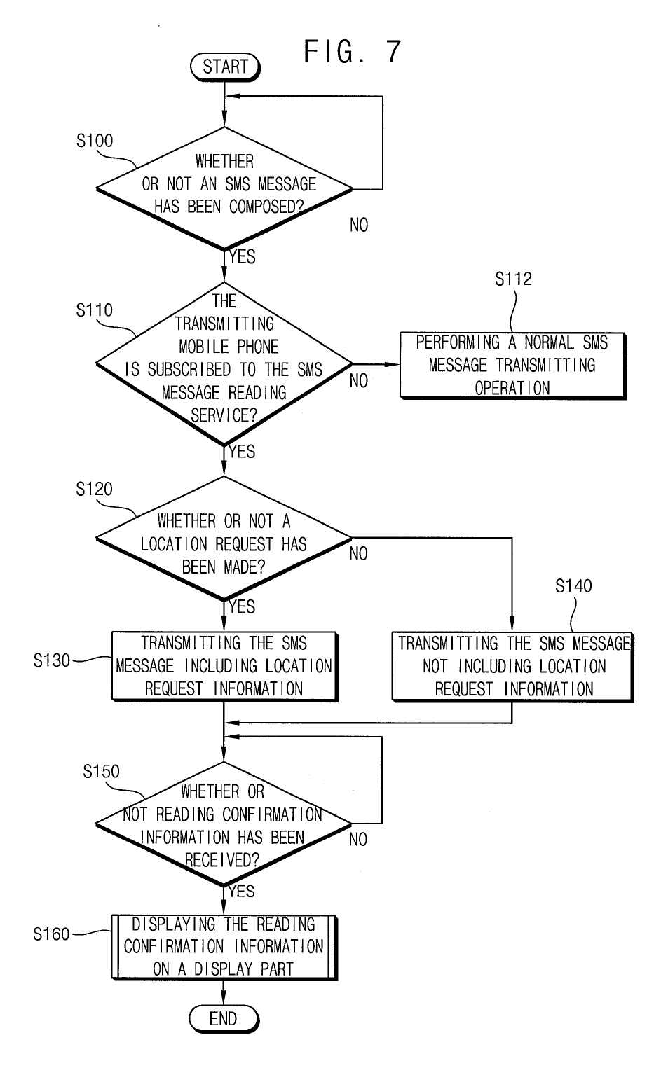

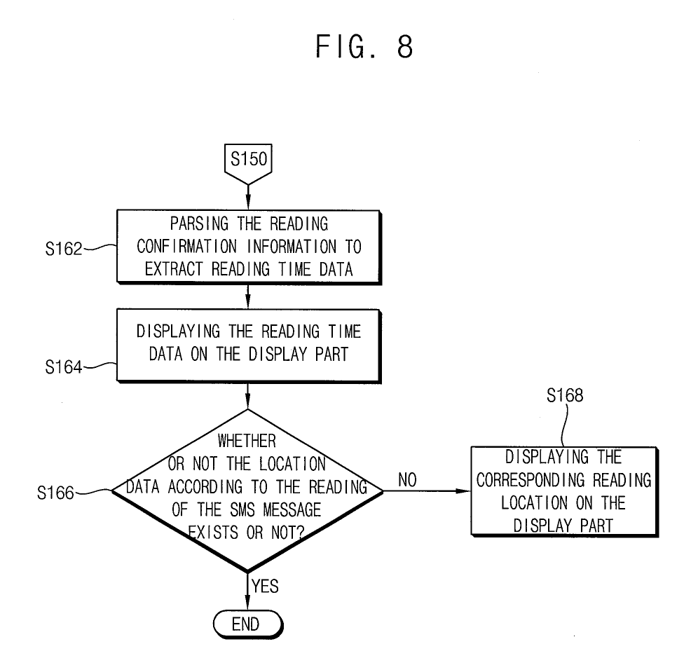

FIG. 7 is a flowchart schematically illustrating a method of a reading-position confirmation service of an SMS message using an SMS message according to an embodiment of the present invention.

Referring to FIGS. 1 and 7, the transmitting mobile phone 100 checks whether an SMS message has been composed or not (step S100).

When the SMS message has been composed in step S100, the transmitting mobile phone 100 oneself checks whether oneself is subscribed to the SMS message reading service or not (step S110).

When it is not checked that the transmitting mobile phone 100 is subscribed to the SMS message reading service in step S110, the transmitting mobile phone 100 performs a normal SMS message transmitting operation (step S112).

When it is checked that the transmitting mobile phone 100 is subscribed to the SMS message reading service in step S110, the transmitting mobile phone 100 checks whether a position request in accordance with a reading of the composed SMS message has been made or not (step S120).

When it is checked that the position request is in accordance with a reading the SMS message in step S120, the transmitting mobile phone 100 transmits the SMS message including position request information (step S130).

When it is checked that the position request is not in accordance with a reading the SMS message in step S120, the transmitting mobile phone 100 transmits the SMS message not including position request information (step S140).

After step S130 or step S140 is performed, the transmitting mobile phone 100 checks whether reading confirmation information has been received or not (step S150).

When it is checked that the reading confirmation information has been received in step S150, the transmitting mobile phone 100 displays the reading confirmation information on a display part (step S160). The reading confirmation information may be a reading time of the SMS message and/or a reading position of the SMS message.

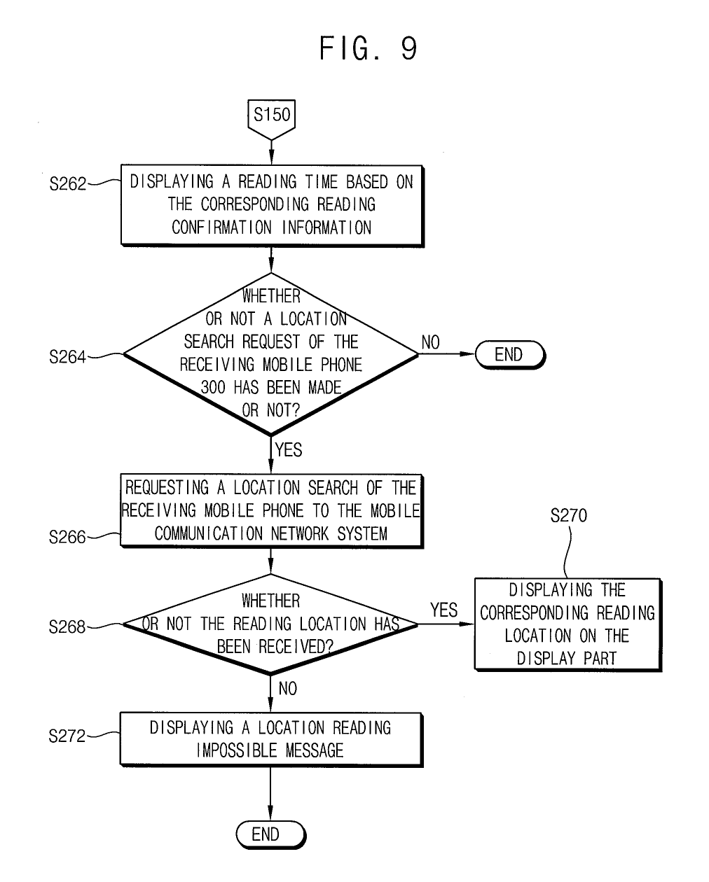

FIG. 8 is a flowchart schematically illustrating an example of step S160 displaying reading-position information of FIG. 7. FIG. 9 is a flowchart schematically illustrating another example of step S160 displaying reading-position information of FIG. 7.

Referring to FIGS. 1, 7 and 8, when the reading confirmation information has been received, the transmitting mobile phone 100 parses the reading confirmation information to extract a reading time data (step S162). Here, when the reading confirmation information further includes reading-position information, the reading position data may be extracted.

Then, the transmitting mobile phone 100 displays the reading time data on the display part (step S164).

Then, the transmitting mobile phone 100 checks whether the position data according to the reading of the SMS message exists or not (step S166). When it is checked that the corresponding position data is not in step S166, an operation of the transmitting mobile phone 100 is ended. When it is checked that the corresponding position data is in step S166, the transmitting mobile phone 100 displays the corresponding reading position on the display part (step S168) to be ended.

Referring to FIG. 9, as the reading confirmation information is received, the transmitting mobile phone 100 displays a reading time based on the corresponding reading confirmation information (step S262).

Then, the transmitting mobile phone 100 checks whether a position search request of the receiving mobile phone 300 has been made or not (step S264).

When the position search request is not checked in step S264, it is ended, and when the position search request is checked in step S264, the transmitting mobile phone 100 requests a position searching of the receiving mobile phone 300 to the mobile communication network system 200 (step S266).

Then, the transmitting mobile phone 100 checks whether or not the reading position has been received (step S268).

When it is checked that the reading position has been received in step S268, the transmitting mobile phone 100 displays the corresponding reading position on the display part (step S270), and then it is to be ended. When it is checked that the reading position is not received in step S268, the transmitting mobile phone 100 displays a position reading impossible message (step S272), and then it is to be ended.

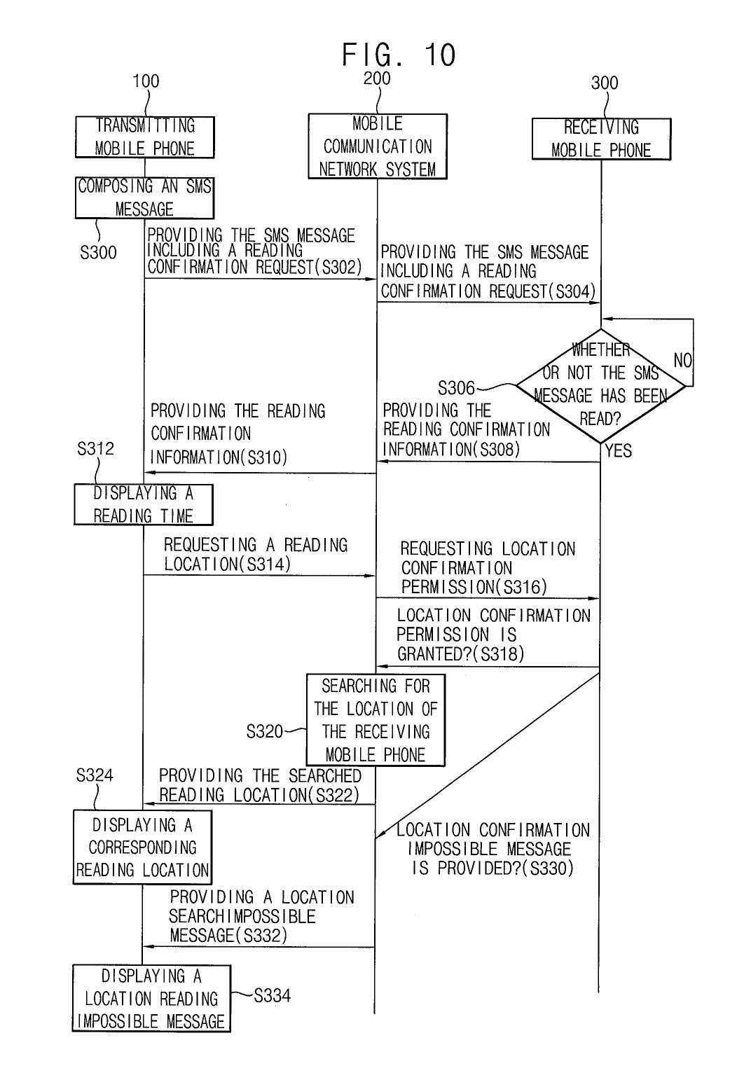

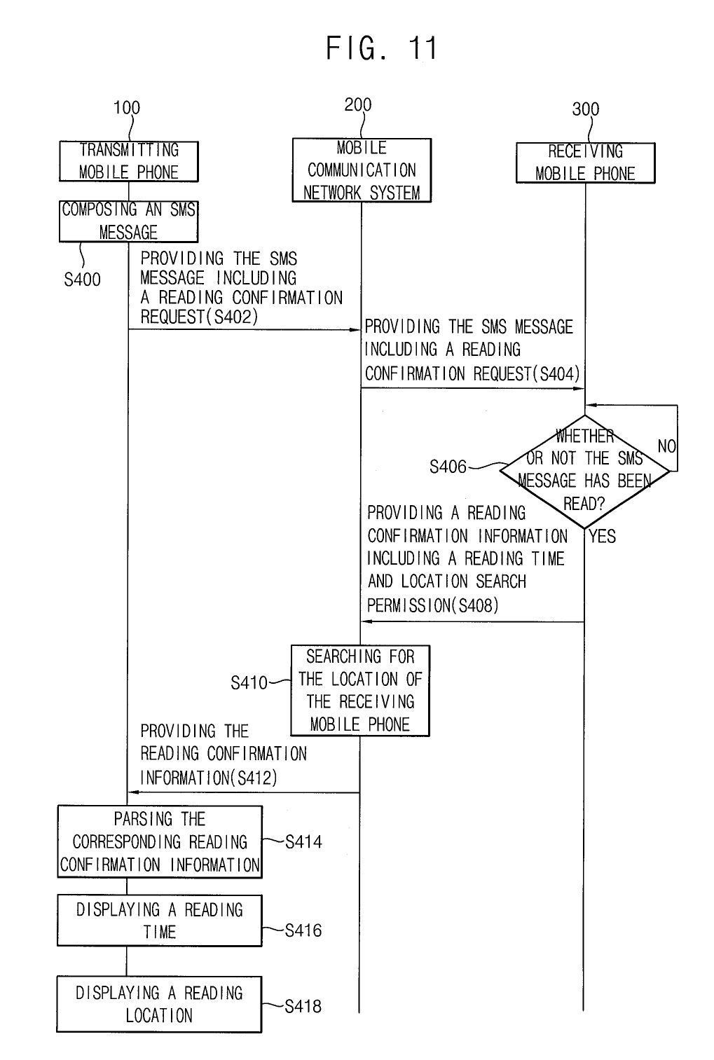

FIG. 10 is a flowchart schematically illustrating a method of a reading-position confirmation service of an SMS message using an SMS message according to another embodiment of the present invention. In FIG. 10, an operation of a reading confirmation in accordance with a position search permission of a receiving mobile phone will be described.

Referring to FIG. 10, as the transmitting mobile phone 100 composed an SMS message (step S300), the transmitting mobile phone 100 provides the mobile communication network 200 with the SMS message including a reading confirmation request to be provided to the receiving mobile phone 300 (step S302).

Then, the mobile communication network 200 provides the receiving mobile phone 300 with the SMS message including the corresponding reading confirmation request (step S304).

As an SMS message is received via the mobile communication network 200, the receiving mobile phone 300 checks whether or not the SMS message has been read in accordance with an operation of a user (step S306).

When it is checked that the SMS message was read in accordance with an operation of a user, the receiving mobile phone 300 provides the mobile communication network system 200 with the reading confirmation information (step S308), and provides the transmitting mobile phone 100 with the corresponding reading confirmation information (step S310).

Then, the transmitting mobile phone 100 displays a reading time based on the reading confirmation information that is provided from the mobile communication network system 200 (step S312).

Then, the transmitting mobile phone 100 requests a reading position to the mobile communication network system 200 (step S314), and then requests a position confirmation permission from the receiving mobile phone 300 (step S316).

As the position confirmation permission is granted from the receiving mobile phone 300 (step S318), the mobile communication network system 200 searches for the position of the receiving mobile phone 300 (step S320), and then provides the receiving mobile phone 100 with the searched reading position (step S322).

As the reading position is provided from the mobile communication network system 200, the transmitting mobile phone 100 displays a corresponding reading position (step S324).

As a position confirmation impossible message is provided from the receiving mobile phone 300 (step S330), the mobile communication network system 200 provides a position search impossible message on the transmitting mobile phone 100 (step S332).

As the position search impossible message is provided from the mobile communication network system 200, the transmitting mobile phone 100 displays a position reading impossible message on a display part (step S334).

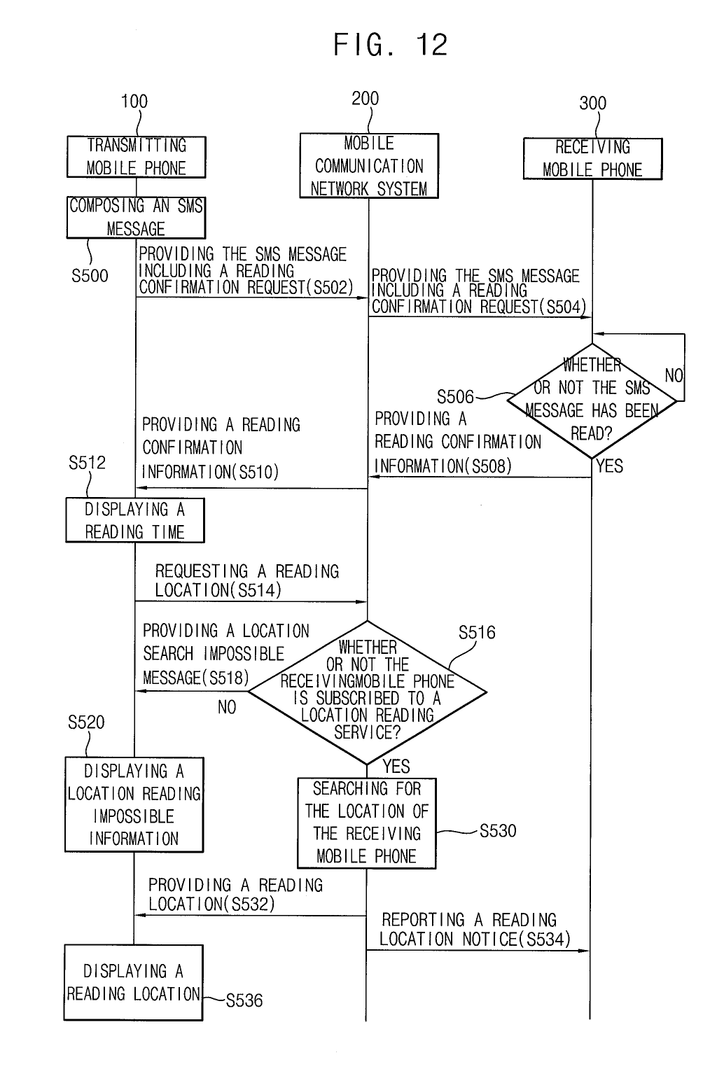

FIG. 11 is a flowchart schematically illustrating a method of a reading-position confirmation service of an SMS message using an SMS message according to still another embodiment of the present invention. In FIG. 11, an operation requesting a reading confirmation to a receiving mobile phone subscribed to a position searching service will be described.

Referring to FIG. 11, as an SMS message is composed by a transmitting mobile phone 100 (step S400), the transmitting mobile phone 100 provides the mobile communication network system 200 with an SMS message including a reading confirmation request (step S402).

Then, the mobile communication network system 200 provides the receiving mobile phone 300 with an SMS message including a reading confirmation request (step S404).

As an SMS message is received via the mobile communication network system 200, the receiving mobile phone 300 checks whether or not an SMS message has been read in accordance with an operation of a user (step S406).

When it is checked that the SMS message has been read in accordance with the operation of a user, the receiving mobile phone 300 provides the mobile communication network system 200 with reading confirmation information including a reading time and position search permission (step S408).

As the reading confirmation information including the reading time and the position search permission is provided from the receiving mobile phone 300, the mobile communication network system 200 searches for the position of the receiving mobile phone 300 (step S410).

Then, the mobile communication network system 200 provides the transmitting mobile phone 100 with reading confirmation information including a reading time and a reading position (step S412).

As the reading confirmation information including a reading time and position search permission, the receiving mobile phone 100 parses the corresponding reading confirmation information to extract a reading time and a reading position (step S414).

Then, the transmitting mobile phone 100 displays the extracted reading time (step S416), and displays the extracted reading position (step S418).

FIG. 12 is flowchart schematically illustrating a method of a reading-position confirmation service of an SMS message using an SMS message according to more still another embodiment of the present invention. In FIG. 12, an operation requesting a reading position of the SMS message in accordance with an operation of a user after the transmitting mobile phone confirms a reading time of the SMS message will be described.

Referring to FIG. 12, as an SMS message is composed by a transmitting mobile phone 100 (step S500), the transmitting mobile phone 100 provides a mobile communication network system 200 with an SMS message including a reading confirmation request (step S502).

Then, the mobile communication network system 200 provides a receiving mobile phone 300 with an SMS message including a reading confirmation request (step S504).

As an SMS message is received via the mobile communication network system 200, the receiving mobile phone 300 checks whether or not the SMS message has been read in accordance with an operation of a user (step S506).

When it is checked that an SMS message has been read in accordance with an operation of a user, the receiving mobile phone 300 provides the mobile communication network system 200 with a reading confirmation information (step S508), and provides the transmitting mobile phone 100 with the corresponding reading confirmation information (step S510).

Then, the transmitting mobile phone 100 displays a reading time of an SMS message based on a reading confirmation information provided from the mobile communication network system 200 (step S512).

Then, the transmitting mobile phone 100 requests a reading position of an SMS message to the mobile communication network system 200 (step S514), and the mobile communication network system 200 checks whether or not the corresponding receiving mobile phone 300 is subscribed to a position reading service (step S516).

In step S516, when it is not checked that the receiving mobile phone 300 is subscribed to the position reading service, the mobile communication network system 200 provides a position search impossible message to the transmitting mobile phone 100 (step S518), and the transmitting mobile phone 100 displays a position reading impossible information in accordance with the position search impossible message (step S520).

When it is checked that the receiving mobile phone 300 is subscribed to a position reading service in step S516, the mobile communication network system 200 searches for the position of the receiving mobile phone 300 (step S530).

Then, the mobile communication network system 200 provides the transmitting mobile phone 100 with a reading position of the receiving mobile phone 300 (step S532), and reports a reading position notice to the receiving mobile phone 300 in accordance with the corresponding reading position notice (step S534).

As a reading position is provided from the mobile communication network system 200, the transmitting mobile phone 100 displays a reading position of the corresponding receiving mobile phone 300 (step S536).

In the above explanations, it was described that the receiving mobile phone joins to the reading-position confirmation service of an SMS message or the receiving mobile phone grants permission to the corresponding position search in accordance with a position search request of the transmitting mobile phone was described.

Alternatively, even though the receiving mobile phone denies permission for the position search, it is possible to confirm a reading time and a reading position according to the present invention.

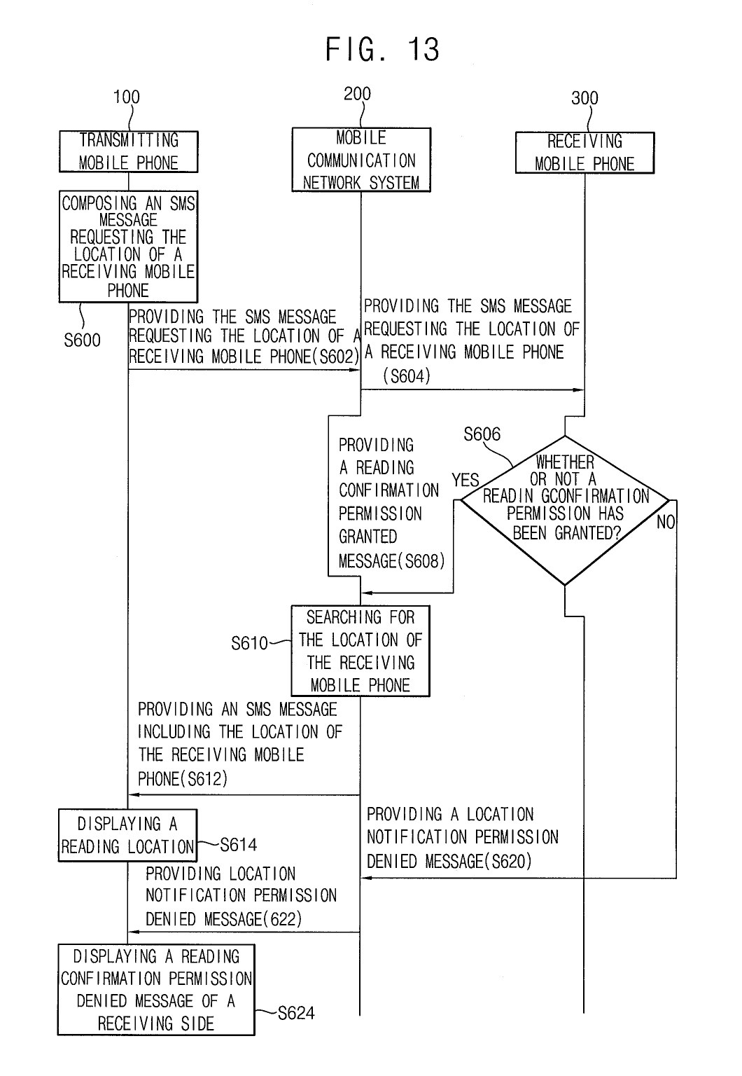

FIG. 13 is flowchart schematically illustrating a method of a reading-position confirmation service of an SMS message using an SMS message according to further still another embodiment of the present invention. Referring to FIG. 13, as the transmitting mobile phone 100 composed an SMS message requesting the position of a receiving mobile phone 300 (step S600), the transmitting mobile phone 100 provides the mobile communication network 200 with the SMS message requesting the position of a receiving mobile phone 300 (step S602).

The mobile communication network system 200 provides the receiving mobile phone 300 with the SMS message requesting a reading confirmation (step S604), and the receiving mobile phone 300 checks whether a reading confirmation permission has been granted or not (step S606).

When the reading confirmation permission is selected by a user, the receiving mobile phone 300 provides the mobile communication network system 200 with a reading confirmation permission granted message (step S608), and the mobile communication network system 200 searches for the position of the receiving mobile phone 610 (step S610).

Then, the mobile communication network system 200 provides the transmitting mobile phone 100 with an SMS message including the position of the receiving mobile phone 300, which searched by the mobile communication network system 200 (step S612). Thus, the transmitting mobile phone 100 displays the position of the receiving mobile phone 300 (step S614). Here, a receiving side position may be displayed in an SMS message of a text type or map information of an image type. When the position of the receiving side includes an SMS message, it is possible to confirm the position of the receiving mobile phone 300 by using a low cost rather than the receiving position included in the map information. Alternatively, when the position of the receiving side includes the map information, it is possible to visibly confirm the position of the receiving mobile phone 300 rather than the receiving position included in the SMS message.

When a reading confirmation permission denied is selected by a user in step S606, the receiving mobile phone 300 provides the mobile communication network system 200 with a position notification permission denied message (step S620).

Then, the mobile communication network system 200 provides the transmitting mobile phone 100 with a position notification permission denied message (step S622), and the transmitting mobile phone 100 displays a reading confirmation permission denied message of a receiving side (step S624).

### INDUSTRIAL APPLICABILITY

According to the present invention, as a receiving side reads an SMS message, a transmitting mobile phone may confirm a reading position of the corresponding SMS message, so that the position of the SMS message receiving side may be easily checked by the transmitting mobile phone. Moreover, a reading time may also be obtained in addition to the reading position information, so that usability of an SMS message may be provided to the SMS message transmitting side.

This invention has been described with reference to the example embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A method for confirming a short message service (SMS) reading position by using an SMS message, which confirms whether or not the SMS message provided from a transmitting mobile phone has been read at a receiving mobile phone, the method comprising:
(a) transmitting an SMS message executed by a user that has subscribed to an SMS message reading confirmation service and information requesting a reading time and a reading position in accordance with a reading of the SMS message; and
(b) displaying a reading time and reading-position information of the SMS message when the reading time and the reading-position information of the SMS message are provided by a receiver from the receiving mobile phone.

2. The method of claim 1, wherein step (a) comprises:
(a-1) checking whether or not position information according to an SMS message reading as the SMS message is composed;
(a-2) transmitting an SMS message including a position information request, when a position information request according to a reading is checked in step (a-1); and
(a-3) transmitting an SMS message which a position information request is not included, when a position information request according to a reading is not checked in step (a-1).

3. The method of claim 1, wherein step (b) comprises:
(b-11) parsing the reading confirmation information in accordance with a receipt of the reading confirmation information;
(b-12) displaying reading time that is extracted in accordance with the parsing;
(b-13) checking whether the reading-position information that is extracted in accordance with the parsing exists or not; and
(b-14) ending when the reading-position information is not in step (b-3) and displaying the corresponding reading-position information when the reading-position information is in step (b-3).

4. The method of claim 1, wherein step (b) comprises:
(b-21) displaying a reading time when the reading confirmation information is received;
(b-22) checking whether a position search request of a receiving side has been made or not;
(b-23) requesting a position search of the receiving side when the position search request of the receiving is checked in step (b-22); and
(b-24) when the reading-position information has been received, displaying corresponding reading-position information.

5. The method of claim 1, wherein the position information includes at least one of address information and map information of the receiving mobile phone.

6. The method of claim 1, wherein an information requesting the reading time and an information requesting the reading position are transmitted at substantially the same time, and
the reading-position information is transmitted with the reading time.

7. The method of claim 6, wherein the reading-position information is obtained in accordance with a request of a user after the reading time is transmitted.

8. The method of claim 7, wherein the reading-position information is forcibly obtained when the receiving mobile phone is subscribed to an SMS message reading confirmation service.

9. The method of claim 7, wherein the reading-position information is obtained in accordance with a position information confirmation permission of the receiving mobile phone according to the corresponding SMS message reading.

10. A method for confirming a reading position of an SMS using an SMS message, which confirms whether or not an SMS message provided from a transmitting mobile phone has been read at a receiving mobile phone, the method comprising:
(a) when the SMS message is provided from the transmitting mobile phone, checking whether or not an information requesting a position confirmation of a reader is included in the SMS message;
(b) when the information requesting a position confirmation of the reader is not included in the SMS message, and a reading confirmation message of the SMS message by a receiver is provided from the receiving mobile phone, transmitting the corresponding reading confirmation message to the transmitting mobile phone; and
(c) when the information requesting a position confirmation of the reader is included in the SMS message, and a reading confirmation message of the SMS message by a receiver is provided from the receiving mobile phone, transmitting the reading confirmation message including a reading position of the receiving mobile phone to the transmitting mobile phone.

11. The method of claim 10, wherein the reading position of the receiving mobile phone comprises at least one of address information of the receiving mobile phone and map information of the receiving mobile phone.

12. A reading-position confirmation terminal device for confirming a reading position of an SMS message by using an SMS message, the mobile phone comprising:
a display part;
a wireless circuit part setting a communication channel with a mobile communication network system; and
a control part transmitting an SMS message composed by a user and information requesting a reading time and a reading position in accordance with a reading the SMS message through the wireless circuit part, and displaying the reading time and the reading position to the display part when a time and a position in accordance with a reading of the SMS message by a user of a receiving mobile phone.

13. The reading-position confirmation terminal device of claim 12, wherein the position comprises at least one of address information of the receiving mobile phone and map information of the receiving mobile phone.

14. The reading-position confirmation terminal device of claim 12, wherein information requesting the reading time and information requesting the reading position are transmitted at substantially the same time, and
the reading position is transmitted together with the reading time.

15. The reading-position confirmation terminal device of claim 12, wherein the reading position is obtained in accordance with a request of a user after the reading time is transmitted.
